(19) United States
(12) Patent Application Publication
(10) Pub. No.: US 2025/0384419 A1
(43) Pub. Date: Dec. 18, 2025

(54) INFORMATION PROCESSING APPARATUS AND METHOD OF CONTROLLING INFORMATION PROCESSING APPARATUS

(71) Applicant: Sharp Kabushiki Kaisha, Sakai City (JP)

(72) Inventor: MAYUKO YOSHIDA, Sakai City (JP)

(21) Appl. No.: 19/223,335

(22) Filed: May 30, 2025

(30) Foreign Application Priority Data
Jun. 13, 2024 (JP) 2024-096228

(51) Int. Cl. G06Q 20/18; G06F 9/451

(52) U.S. Cl. CPC G06Q 20/18; G06F 9/453

(57) ABSTRACT

An information processing apparatus includes a controller, a display, a first payment processor that executes first payment processing, and a connector that is connectable to a payment terminal that executes second payment processing. The controller displays, on the display, a payment screen related to the first payment processing when executing the first payment processing by the first payment processor, and displays, on the display, a payment terminal guiding screen used to guide a user to the payment terminal when requesting, via the connector, the payment terminal to execute the second payment processing.

### FIELD OF THE INVENTION

The disclosure relates to an image forming apparatus and the like.

### BACKGROUND ART

An image forming apparatus such as a Multi-Function Printer/Peripheral (MFP) that provides various paid services is installed in a store such as a convenience store or a public space such as a government agency. In general, payment methods for executing payments related to services provided by this type of image forming apparatus are roughly classified into cash payment and cashless payment. The cashless payment may use, for example, a credit card, a prepaid card, or the like, but in recent years, new cashless payment such as two-dimensional code payment has also emerged.

An information processing apparatus is known that includes a payment unit that pays a price for a function related to image processing executed in an image forming apparatus based on data read from a payment medium.

### SUMMARY

### Technical Problem

In a known information processing apparatus, operability of an externally added payment terminal supporting cashless payment is not considered.

A problem to be solved by the present disclosure is to improve operability related to payment for a job executed by an image forming apparatus.

### Solution to Problem

The present disclosure provides an information processing apparatus including a controller, a display, a first payment processor that executes first payment processing, and a connector that is connectable to a payment terminal that executes second payment processing, wherein the controller displays, on the display, a payment screen related to the first payment processing when executing the first payment processing by the first payment processor, and displays, on the display, a payment terminal guiding screen used to guide a user to the payment terminal when requesting, via the connector, the payment terminal to execute the second payment processing.

The present disclosure provides a method of controlling an information processing apparatus including a display, a first payment processor that executes first payment processing, and a connector that is connectable to a payment terminal that executes second payment processing, the method including displaying, on the display, a payment screen related to the first payment processing when executing the first payment processing by the first payment processor, and displaying, on the display, a payment terminal guiding screen used to guide a user to the payment terminal when requesting, via the connector, the payment terminal to execute the second payment processing.

### Advantageous Effects of Disclosure

According to the present disclosure, operability related to payment for a job executed by an image forming apparatus can be improved.

### BRIEF DESCRIPTION OF THE DRAWINGS

FIG. 1 is a schematic diagram of appearance of a payment system according to a first embodiment of the disclosure.

FIG. 2 is a functional block diagram of the payment system according to the first embodiment of the disclosure.

FIG. 3 is a flowchart for describing operation of an expansion device of the payment system according to the first embodiment of the disclosure.

FIG. 4 is a flowchart for describing operation of the expansion device of the payment system according to the first embodiment of the disclosure.

FIGS. 5A and 5B illustrate examples of screens displayed on the expansion device of the payment system according to the first embodiment of the present disclosure; FIG. 5A is an example of a payment method selection screen, and FIG. 5B is an example of an electronic money selection screen.

FIGS. 6A and 6B illustrate examples of screens displayed on the expansion device of the payment system according to the first embodiment of the present disclosure; FIG. 6A is an example of a payment screen, and FIG. 6B is an example of a payment completion screen.

FIGS. 7A and 7B illustrate examples of screens displayed on the expansion device of the payment system according to the first embodiment of the present disclosure; FIG. 7A is an example of a job execution screen, and FIG. 7B is another example of the payment method selection screen.

FIGS. 8A and 8B illustrate screens displayed on the expansion device of the payment system according to the first embodiment of the present disclosure; FIG. 8A is an example of a payment start screen, and FIG. 8B is an example of a payment terminal guiding animation screen.

FIG. 9 is the former half of a flowchart for describing operation of an expansion device of a payment system according to a second embodiment of the disclosure.

FIG. 10 is the latter half of the flowchart for describing the operation of the expansion device of the payment system according to the second embodiment of the disclosure.

FIGS. 11A and 11B include schematic diagrams for describing operation of the payment system according to the second embodiment of the present disclosure; FIG. 11A is a schematic diagram illustrating control of a light emission state of a display of a payment terminal, and FIG. 11B is a schematic diagram illustrating control of the light emission state of the display of the expansion device.

FIG. 12 is a functional block diagram of a payment system according to a third embodiment of the disclosure.

FIG. 13 is the former half of a flowchart for describing operation of an expansion device of the payment system according to the third embodiment of the disclosure.

FIG. 14 is the latter half of the flowchart for describing the operation of the expansion device of the payment system according to the third embodiment of the disclosure.

FIGS. 15A and 15B include schematic diagrams for describing operation of the payment system according to the third embodiment of the present disclosure; FIG. 15A is a schematic diagram illustrating a state in which the expansion device outputs a voice message guiding a user to the payment terminal, and FIG. 15B is a schematic diagram illustrating a state in which the payment terminal outputs a voice message guiding the user to the expansion device.

FIGS. 16A and 16B include schematic diagrams for describing an operation of a payment system according to a fourth embodiment of the present disclosure; FIG. 16A is a schematic diagram illustrating a state in which the image forming apparatus and the expansion device display a message guiding a user to the payment terminal, and FIG. 16B is a schematic diagram illustrating a state in which the payment terminal and the image forming apparatus display a message guiding the user to the expansion device.

FIGS. 17A and 17B illustrate examples of screens displayed on an expansion device of a payment system according to a fifth embodiment of the present disclosure; FIG. 17A is an example of a screen displayed after an administrative service is utilized, and FIG. 17B is an example of a screen displayed after a copy service is utilized.

FIGS. 18A and 18B include examples of screens displayed on an expansion device of a payment system according to a sixth embodiment of the present disclosure; FIG. 18A is an example of a screen displayed in a case where payment is made in cash, and FIG. 18B is an example of a screen displayed when cashless payment is made.

### DESCRIPTION OF EMBODIMENTS

### 1. First Embodiment

### 1.1 Hardware Configuration of Payment System 1

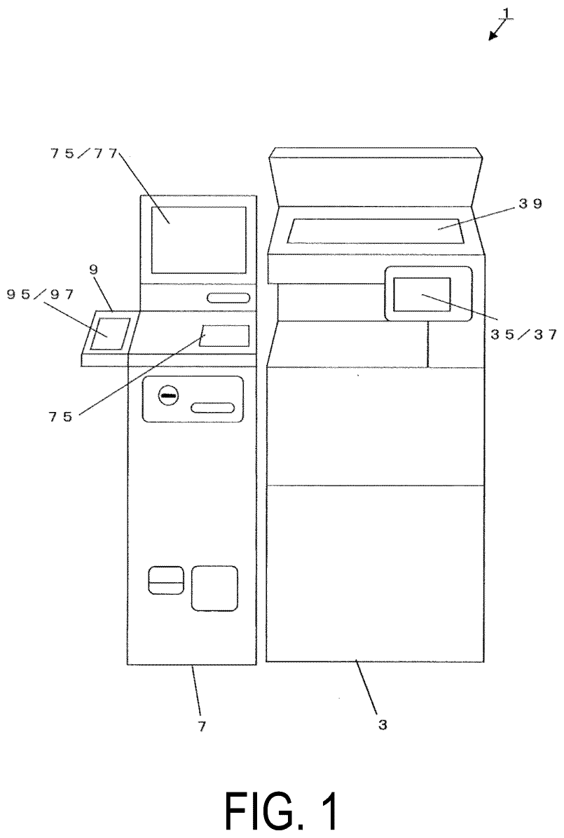

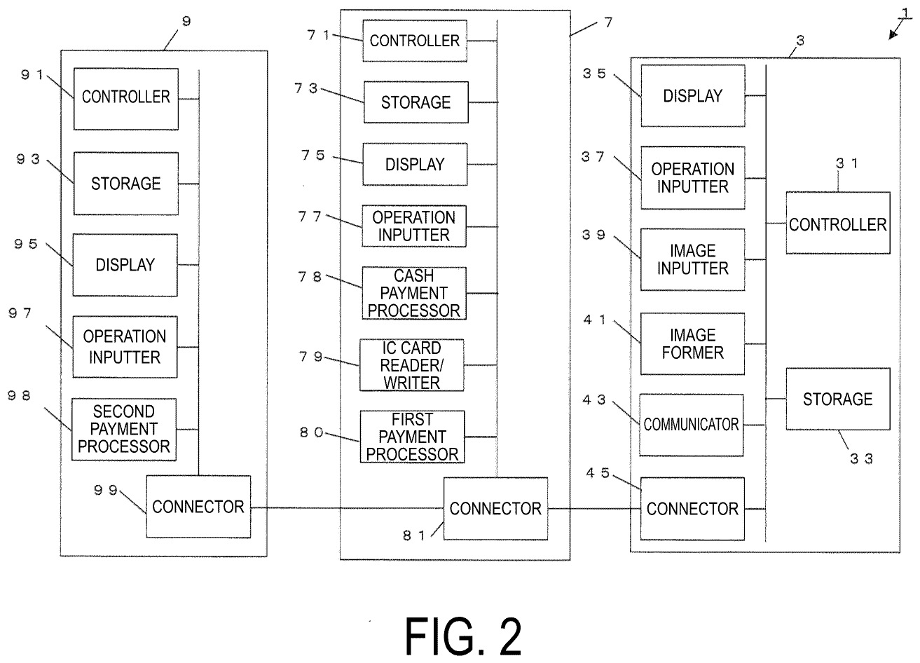

FIG. 1 is a schematic diagram of appearance of a payment system 1 according to a first embodiment of the disclosure. FIG. 2 is a functional block diagram of the payment system 1 according to the first embodiment of the disclosure. The payment system 1 includes an image forming apparatus 3, an expansion device 7, and a payment terminal (external terminal) 9.

### 1.1.1 Image Forming Apparatus 3

The image forming apparatus 3 is a Multi-Function Printer/Peripheral (MFP) or a multifunction peripheral, and typically includes a copy function, an image scanner function, a facsimile function, and a printer function. The image forming apparatus 3 may further include other functions, for example, an e-mail transmission and/or reception function, a file server function, and the like. The image forming apparatus 3 includes a controller 31, a storage 33, a display 35, an operation inputter 37, an image inputter 39, an image former 41, a communicator 43, and a connector 45.

The controller 31 controls the entirety of the image forming apparatus 3. The controller 31 includes, for example, one or more control devices or control circuits, and includes, for example, a Central Processing Unit (CPU) or a System on a Chip (SoC) that is a processor that executes various types of arithmetic processing. The controller 31 can realize each function by reading programs stored in the storage 33 and executing processing.

The storage 33 stores various programs and various data necessary for operation of the image forming apparatus 3. The storage 33 includes one or more recording devices capable of temporary storage, such as a Dynamic Random Access Memory (DRAM), or one or more non-temporary recording devices such as a Solid State Drive (SSD) including a semiconductor memory or a Hard Disk Drive (HDD) including a magnetic disk. Although illustrated as a single component for convenience of description, the storage 33 may be configured as separate devices for respective applications, such as a region (main storage region) utilized for execution of a program, a region (auxiliary storage region) for storing programs or data, and a region utilized for a cache.

The display 35 is a display device that displays images and characters. The display 35 includes, for example, a Liquid Crystal Display (LCD) or an organic Electro-Luminescence (EL) panel.

The operation inputter 37 receives an operation input from the user. For example, the operation inputter 37 includes hardware keys or software keys. The operation inputter 37 includes task keys for instructing execution of tasks such as fax transmission and image loading, and a cancel key for instructing cancellation of an operation, for example. The display 35 and the operation inputter 37 may be integrally configured as a touch panel display.

The image inputter 39 reads an image (document) and outputs the image as image data. The image inputter 39 includes a typical scanner (image input device). The image inputter 39 may receive, as an input, image data read from an external storage medium such as a Universal Serial Bus (USB) memory, or may receive image data via a network as an input.

The image former 41 forms (prints) an image on a medium such as a copy sheet based on the image data. A printing method of the image former 41 is as desired, and may be, for example, any one of an inkjet printer, a laser printer, and a thermal transfer printer. The image former 41 may be a monochrome printer or a color printer. The image former 41 may include a paper feeding mechanism that feeds a medium, a conveyance mechanism that conveys a medium, a sorter mechanism that sorts media on which images have been formed, or the like.

The communicator 43 connects to the network. For example, the communicator 43 includes an interface connectible to a wired local area network (LAN), a wireless LAN, or a long term evolution (LTE) network. When connected to a network, the communicator 43 is connected to other devices or an external network. The communicator 43 may otherwise be an interface that performs short-range wireless communication such as Near field communication (NFC) or Bluetooth (trade name), for example.

The connector 45 connects the image forming apparatus 3 to another piece of equipment. In particular, the connector 45 connects the image forming apparatus 3 to the expansion device 7. For example, the connector 45 is a USB interface, and connects to a USB memory or the like. Other than a USB interface, the connector 45 may be an interface such as HDMI (trade name). Note that the connector 45 may be connected to the payment terminal 9.

### 1.1.2 Expansion Device 7

The expansion device 7 is an example of an information processing apparatus that is connected to the image forming apparatus 3 to expand the functions of the image forming apparatus 3 and add, to the image forming apparatus 3, functions not included in the image forming apparatus 3. The expansion device 7 includes a controller 71, a storage 73, a display 75, an operation inputter 77, a cash payment processor 78, an IC card reader/writer 79, a first payment processor 80, and a connector 81.

The controller 71 controls the entire expansion device 7. The controller 71 includes, for example, one or more control devices or control circuits, and includes, for example, a Central Processing Unit (CPU) or a System on a Chip (SoC) that is a processor that executes various types of arithmetic processing. The controller 71 realizes each function by reading programs stored in the storage 73 and executing processing.

The storage 73 stores various programs and various data necessary for operation of the expansion device 7. The storage 73 includes one or more recording devices capable of temporary storage, such as a Dynamic Random Access Memory (DRAM), or one or more non-temporary recording devices such as a Solid State Drive (SSD) including a semiconductor memory or a hard disk drive (HDD) including a magnetic disk. Although illustrated as a single component for convenience of description, the storage 73 may be configured as separate devices for each application, such as a region (main storage region) utilized for execution of a program, a region (auxiliary storage region) for storing programs or data, and a region utilized for a cache.

The display 75 displays images and characters. The display 75 includes, for example, a Liquid Crystal Display (LCD) or an organic Electro-Luminescence (EL) panel. The display 75 has a screen size larger than that of the display 35 of the image forming apparatus 3.

The operation inputter 77 receives an operation input from the user. For example, the operation inputter 77 includes hardware keys or software keys. The operation inputter 77 includes task keys for instructing execution of tasks such as fax transmission and image reading, and a cancel key for instructing cancellation of an operation, for example. Note that, in the present embodiment, the display 75 and the operation inputter 77 may be integrally configured as a touch panel display.

The cash payment processor 78 includes an insertion slot through which coins and bills are inserted and a return slot through which coins and bills are discharged, and performs processing for giving and receiving cash, counting and conveying cash accompanying the giving and receiving of cash, and the like.

The IC card reader/writer 79 is a reader/writer device that performs reading and writing on an Integrated Circuit (IC) card. The IC card reader/writer 79 may correspond to a contact type IC card or a non-contact type IC card, but preferably corresponds to both a contact type IC card and a non-contact type IC card.

The first payment processor 80 executes processing related to cashless payment performed by the expansion device 7. For example, the first payment processor 80 uses the IC card reader/writer 79 to perform reading or writing on an IC-card charged with electronic money, and uses the connector 81 to communicate with a server of a payment agency company or an electronic-money payment organization via the image forming apparatus 3 (the connector 45 and the communicator 43), thus executing processing related to electronic-money payment. Communication with the server of the payment agency company or the electronic-money payment organization may be performed via a communicator (not illustrated) included in the expansion device 7.

The connector 81 connects the expansion device 7 to another piece of equipment. In particular, the connector 81 connects the expansion device 7 to the image forming apparatus 3 and the payment terminal 9. For example, the connector 81 is a USB interface, and connects to a USB memory or the like. Other than a USB interface, the connector 81 may be an interface such as an HDMI (trade name).

### 1.1.3 Payment Terminal 9

The payment terminal 9 is a device controlled by a controller 91 different from the controller 31 of the image forming apparatus 3. The payment terminal 9 includes a controller 91, a storage 93, a display 95, an operation inputter 97, a second payment processor 98, and a connector 99.

The controller 91 controls the entire payment terminal 9. The controller 91 includes, for example, one or more control devices or control circuits, and includes, for example, a Central Processing Unit (CPU) or a System on a Chip (SoC) that is a processor that executes various types of arithmetic processing. The controller 91 realizes each function by reading programs stored in the storage 93 and executing processing.

The storage 93 stores various programs and various data necessary for operation of the payment terminal 9. The storage 93 includes one or more recording devices capable of temporary storage, such as a Dynamic Random Access Memory (DRAM), or one or more non-temporary recording devices such as a Solid State Drive (SSD) including a semiconductor memory or a Hard Disk Drive (HDD) including a magnetic disk. Although illustrated as a single component for convenience of description, the storage 93 may be configured as separate devices for respective applications, such as a region (main storage region) utilized for execution of a program, a region (auxiliary storage region) for storing programs or data, and a region utilized for a cache.

The display 95 is a display device that displays images and characters. The display 95 includes, for example, a Liquid Crystal Display (LCD) or an organic Electro-Luminescence (EL) panel.

The operation inputter 97 receives an operation input from the user. For example, the operation inputter 97 includes hardware keys or software keys. The operation inputter 97 includes task keys such as an execution key for instructing execution of payment processing related to cashless payment and a cancel key for canceling cashless payment. Note that the display 95 and the operation inputter 97 may be integrally configured as a touch panel display.

The second payment processor 98 executes processing related to cashless payment performed by the payment terminal 9. The cashless payment operations performed by the second payment processor 98 may include cashless payment operations different from those that can be executed by the first payment processor 80 of the expansion device 7. For example, the second payment processor 98 executes processing related to two-dimensional barcode payment by displaying a two-dimensional barcode for two-dimensional barcode payment on the display 95, and using the connector 99 to communicate with a server of payment agency company or a two-dimensional barcode payment organization via the expansion device 7 (the connector 81) and/or the image forming apparatus 3 (the connector 45 and the communicator 43). The two-dimensional barcode payment is, for example, PayPay of PayPay Cooperation, Rakuten Pay of Rakuten Payment Inc., LINE Pay of LY Corporation, or D PAYMENT of NTT DOCOMO, INC. Note that communication with the server of the payment agency company or the two-dimensional barcode payment organization may be performed via a communicator (not illustrated) included in the expansion device 7 or the payment terminals 9.

The connector 99 connects the payment terminal 9 to another piece of equipment. In particular, the connector 99 connects the payment terminal 9 to the expansion device 7, but may be connected to the image forming apparatus 3. For example, the connector 99 is a USB interface, and connects to a USB memory or the like. Other than a USB interface, the connector 99 may be an interface such as an HDMI (trade name). Note that, in FIG. 2, the connectors 45, 81, and 99 are connected in a so-called daisy chain form in which the connectors 45, 81, and 99 are linearly connected, but that the present disclosure does not particularly limit the connection form, and the connectors 45, 81, and 99 may be connected in a so-called star form around the connector 45.

### 1.2 Operation of Payment System 1

The operation of the payment system 1 will be described focusing on the expansion device 7. The payment system 1 handles three main types of payment processing (first payment processing, second payment processing, and cash payment processing). Both the first payment processing and the second payment processing are cashless payment. The first payment processing is executed by the first payment processor 80 included in the expansion device 7. The second payment processing is executed by the second payment processor 98 of the payment terminal 9 connected (externally attached) to the expansion device 7. The cash payment processing is executed by the cash payment processor 78 included in the expansion device 7.

The payment system 1 executes either the first payment processing or the second payment processing, which is cashless payment. For which of the first payment processing and the second payment processing is to be executed, for example, on an operation setting screen (not illustrated) of the expansion device 7, whether to execute the payment processing may be set for each of the first payment processing and the second payment processing, as an operation setting for the expansion device 7. For example, the expansion device 7 may detect whether the payment terminal 9 is connected to the connector 81, and may execute either the first payment processing or the second payment processing according to the detection result. In this case, the expansion device 7 executes the first payment processing in a case where the connection of the payment terminal 9 to the connector 81 is not detected, and executes the second payment processing in a case where the connection of the payment terminal 9 to the connector 81 is detected.

1.2.1 Operation of Payment System 1 (Case in which First Payment Processing is Executable)

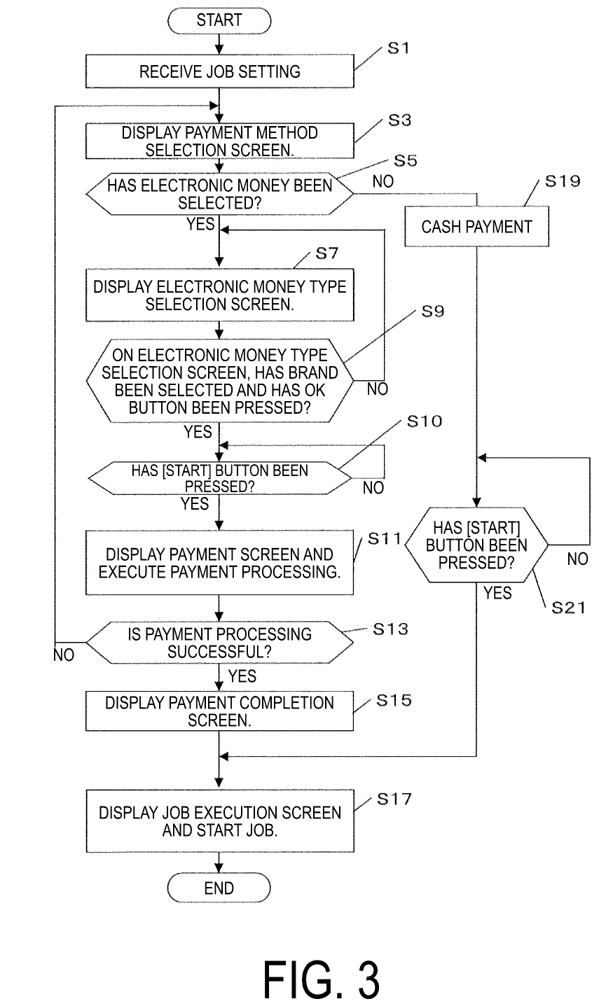

FIG. 3 is a flowchart for describing operation of the expansion device 7 of the payment system 1 according to the first embodiment of the disclosure.

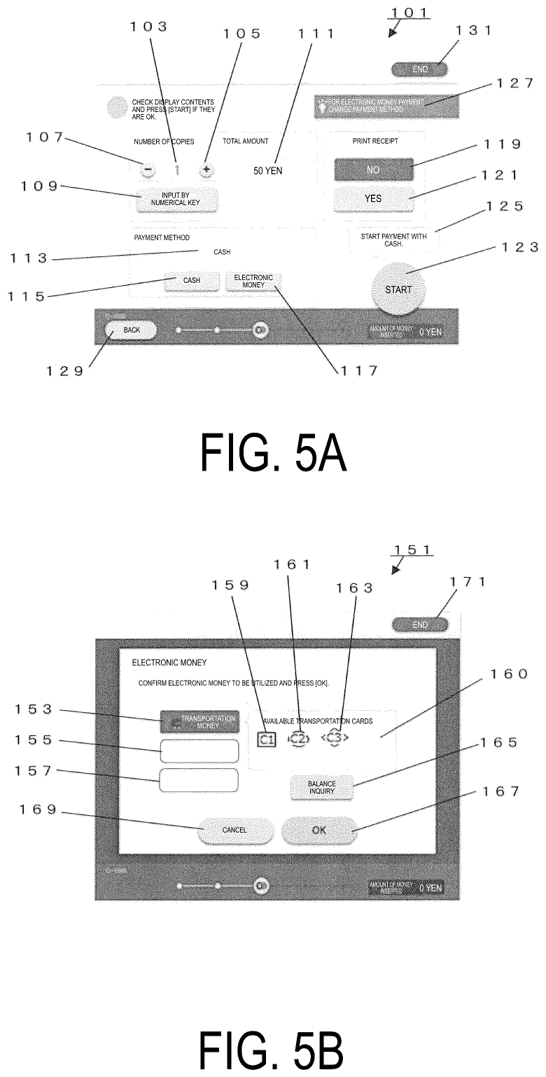

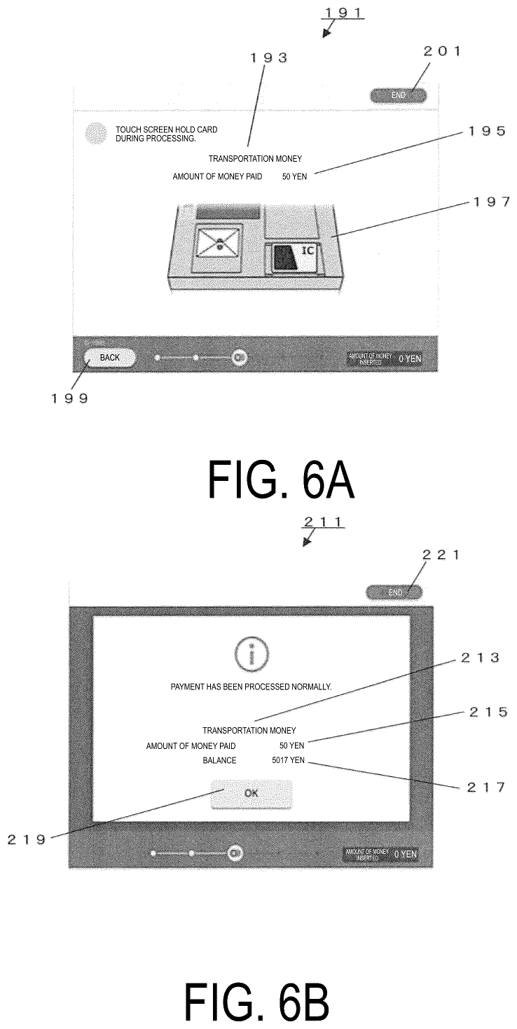

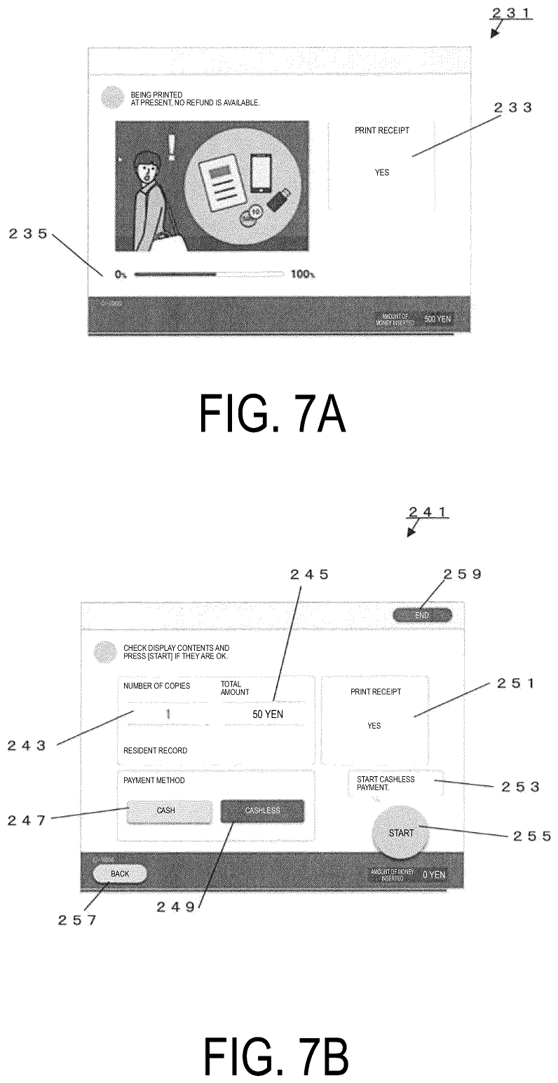

The controller 71 receives a setting of a job via the operation inputter 77 (step S1). Then, the controller 71 displays a payment method selection screen on the display 75 (step S3). An example of the payment method selection screen is illustrated in FIG. 5A. Details are described below. In a case where electronic money is selected on the payment method selection screen via the operation inputter 77 (Yes in step S5), the controller 71 displays an electronic-money type selection screen on the display 75 (step S7). An example of the electronic-money type selection screen is illustrated in FIG. 5B. Details are described below. The controller 71 continues to display the electronic-money type selection screen until the type of electronic money is selected and the OK button is pressed on the electronic-money type selection screen (No in step S9). When the type (brand) of electronic money is selected and the OK button is pressed on the electronic-money type selection screen via the operation inputter 77 (Yes in step S9), the controller 71 waits for the [Start] button on the payment method selection screen to be operated (No in step S10). When the [start] button on the payment method selection screen is operated via the operation inputter 77 (Yes in step S10), the controller 71 causes the first payment processor 80 to execute the payment processing. The first payment processor 80 displays a payment screen on the display 75 and executes the payment processing (step S11). An example of the payment screen is illustrated in FIG. 6A. Details are described below. In a case where the payment processing is successful (Yes in step S13), the controller 71 displays a payment completion screen on the display 75 (step S15). An example of the payment completion screen is illustrated in FIG. 6B. Details are described below. After displaying the payment completion screen, the controller 71 displays a job execution screen on the display 75 and requests the image forming apparatus 3 via the connector 81 to start the job in accordance with the setting received in step S1 (step S17). An example of the job execution screen is illustrated in FIG. 7A. Details are described below. When the image forming apparatus 3 receives a job start request from the expansion device 7 via the connector 45, the controller 31 executes the requested job. In a case where the payment processing fails (No in step S13), the controller 71 returns the processing to step S3. In a case where the electronic money is not selected in step S5 (the cash payment is selected) (No in step S5), the controller 71 causes the cash payment processor 78 to execute the payment processing by cash (step S19). After the cash payment, the controller 71 waits for the [start] button on the payment method selection screen to be operated (No in step S21). When the [Start] button on the payment method selection screen is operated via the operation inputter 77 (Yes in step S21), the controller 71 requests the image forming apparatus 3 via the connector 81 to start the job according to the setting received in step S1 (step S17). When the image forming apparatus 3 receives the job start request from the expansion device 7 via the connector 45, the controller 31 executes the requested job.

1.2.2 Operation of Payment System 1 (Case where Second Payment Processing is Executable)

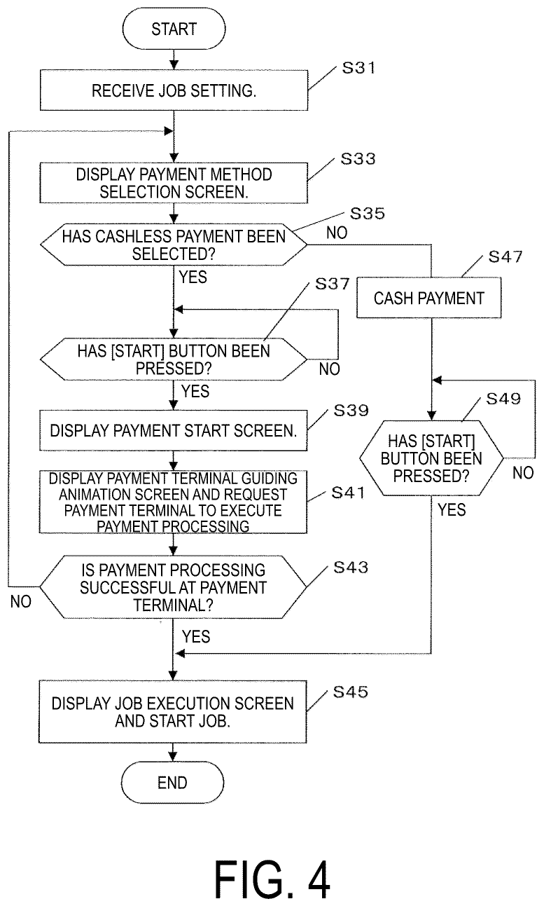

FIG. 4 is a flowchart for describing operation of the expansion device 7 of the payment system 1 according to the first embodiment of the disclosure.

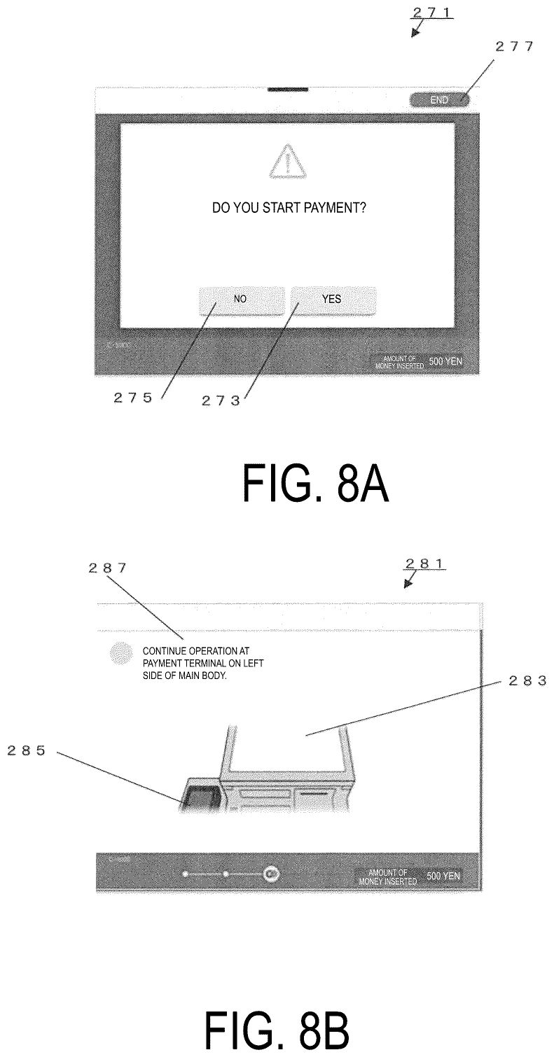

The controller 71 receives a setting of a job via the operation inputter 77 (step S31). Then, the controller 71 displays a payment method selection screen on the display 75 (step S33). An example of the payment method selection screen is illustrated in FIG. 7B. Details are described below. In a case where cashless payment is selected on the payment method selection screen via the operation inputter 77 (Yes in step S35), the controller 71 waits for the [start] button to be operated via the operation inputter 77 (No in step S37). When the [Start] button is operated via the operation inputter 77 (Yes in step S37), the controller 71 displays a payment start screen on the display 75 (step S39). An example of the payment start screen is illustrated in FIG. 8A. Details are described below. When a “Yes” button is operated on the payment start screen via the operation inputter 77, the controller 71 displays a payment terminal guiding animation screen on the display 75 (step S41). An example of the payment terminal guiding animation screen is illustrated in FIG. 8B. Details are described below. At this time, the controller 71 transmits a payment request for requesting, via the connector 81, the payment terminal 9 to execute the payment processing.

When the payment terminal 9 receives the payment request via the connector 99, the controller 91 causes the second payment processor 98 to execute the second payment processing. The controller 91 transmits, to the expansion device 7 via the connector 99, a payment request response indicating the success or failure of the payment processing.

When the payment request response indicating the success of the payment is received from the payment terminal 9 via the connector 81 (Yes in step S43), the controller 71 displays the job execution screen on the display 75 and requests the image forming apparatus 3 to start the job according to the setting received in step S31 via the connector 81 (step S45). When the image forming apparatus 3 receives the job start request from the expansion device 7 via the connector 45, the controller 31 executes the requested job. An example of the job execution screen is illustrated in FIG. 7A. Details are described below.

In a case where the cashless payment is not selected in step S35 (the cash payment is selected) (No in step S35), the controller 71 performs payment by cash (step S49). After the cash payment, the controller 71 waits for the [start] button on the payment method selection screen to be operated (step S49, No). When the [Start] button on the payment method selection screen is operated via the operation inputter 77 (Yes in step S49), the controller 71 requests the image forming apparatus 3 via the connector 81 to start the job according to the setting received in step S31 (step S45). When the image forming apparatus 3 receives the job start request from the expansion device 7 via the connector 45, the controller 31 executes the requested job.

### 1.3 Example of Screen

FIGS. 5A, 5B, 6A, and 6B described below are examples of screens displayed on the display 75 when the first payment processing illustrated in FIG. 3 is executed. FIGS. 7B, 8A, and 8B are examples of screens displayed on the display 75 when the second payment processing illustrated in FIG. 4 is executed. The screen of FIG. 7A is an example of a screen displayed on the display 75 in the first payment processing and the second payment processing.

### 1.3.1 Payment Method Selection Screen 101

FIGS. 5A and 5B are diagrams illustrating an example of a screen displayed on the expansion device 7 of the payment system 1 according to the first embodiment of the present disclosure. A payment method selection screen 101 in FIG. 5A is an example of the payment method selection screen displayed in step S3 in FIG. 3. The payment method selection screen 101 includes a number-of-copies indication 103, number-of-copies input buttons 105, 107, and 109, an amount indication 111, a payment method indication 113, buttons 115, 117, 119, 121, and 123, a balloon indication 125, a message indication 127, and buttons 129 and 131.

The number-of-copies indication 103 is a numerical value indicating the number of copies to be printed. The number-of-copies input button 105 is a button for increasing the numerical value of the number-of-copies indication 103, and the controller 71 increases the numerical value of the number-of-copies indication 103 by one each time the button 105 is operated via the operation inputter 77. The number-of-copies input button 107 is a button for decreasing the numerical value of the number-of-copies indication 103, and the controller 71 decreases the numerical value of the number-of-copies indication 103 by one each time the button 107 is operated once via the operation inputter 77. The number-of-copies input button 109 is a button for changing the numerical value of the number-of-copies indication 103. After the button 109 is operated via the operation inputter 77, the controller 71 changes the numerical value of the number-of-copies indication 103 to the numerical value input by the numerical key of the operation inputter 77.

The amount indication 111 is a numerical value indicating the total amount. The controller 71 calculates a value by multiplying the numerical value displayed in the number-of-copies indication 103 by an amount per copy stored in advance in the storage 73, and displays the calculated numerical value in the amount indication 111.

The payment method indication 113 indicates a currently selected payment method. The button 115 is used to select the cash payment as the payment method. When the cash button 115 is operated via the operation inputter 77, the controller 71 selects the cash payment as the payment method and sets the display of the payment method indication 113 to “cash”. The button 117 is used to select electronic money payment as the payment method. When the electronic money button 117 is operated via the operation inputter 77, the controller 71 selects the electronic money payment as the payment method and sets the display of the payment method indication 113 to “electronic money”.

The button 119 indicates that no receipt is printed. When the no-receipt printing button 119 is operated via the operation inputter 77, the controller 71 changes a display form of the no-receipt printing button 119 (for example, colors the no-receipt printing button 119) to indicate that the no-receipt printing button 119 is in a selected state. The button 121 indicates that a receipt is to be printed. When the receipt printing button 121 is operated via the operation inputter 77, the controller 71 indicates that the receipt printing button 121 is in the selected state by changing the display form of the receipt printing button 121 (for example, coloring the receipt printing button 121). The no-receipt printing button 119 and the receipt printing button 121 are displayed in a (identifiable) display form indicating that one of the buttons is in the selected state.

The button 123 is used to instruct the start of payment using the payment method indicated by the payment method indication 113. When the start button 123 is operated via the operation inputter 77, the controller 71 displays, on the display 75, a screen corresponding to the payment method indicated by the payment method indication 113.

The balloon indication 125 is a display field for displaying a payment method to be started when the start button 123 is operated at the present time, and displays a message indicating that payment is started by the same payment method as that indicated by the payment method indication 113. In FIG. 5A, since “cash” is displayed in the payment method indication 113, a message “Payment is started with cash” is displayed in the balloon indication 125.

The message indication 127 prompts a user who desires to make payment by a payment method different from the payment method indicated by the payment method indication 113 to perform an operation of changing the payment method. In FIG. 5A, since “cash” is displayed in the payment method indication 113, “Change the payment method for payment with electronic money” is displayed in the message indication 127.

The button 129 is used to return the job setting screen (not illustrated) displayed in step S1. When the return button 129 is operated via the operation inputter 77, the controller 71 displays the job setting screen on the display 75. The button 131 is used to interrupt (end) execution of the job. When the end button 131 is operated via the operation inputter 77, the controller 71 displays an initial screen (not illustrated) of the expansion device 7 on the display 75.

### 1.3.2 Electronic Money Selection Screen 151

An electronic money selection screen 151 in FIG. 5B is an example of the electronic money selection screen displayed in step S7 in FIG. 3. When the electronic money button 117 is operated on the payment method selection screen 101, the controller 71 displays the electronic money selection screen 151 on the display 75. The electronic money selection screen 151 includes buttons 153, 155, and 157, a display field 160, icons 159, 161, and 163, and buttons 165, 167, 169, and 171.

Buttons 153, 155, and 157 indicate groups into which electronic money is classified, respectively. For example, the button 153 indicates transportation electronic money. Although no group name is indicated on the button 155 or 157, the buttons may be labeled, for example, distribution electronic money, credit card electronic money, QR code (trade name) electronic money, or the like. Any one of the buttons 153, 155, and 157 is displayed in a display form representing the selected state, and the remaining buttons are displayed in a display form representing an unselected state. In FIG. 5B, the button 153 is colored and the buttons 155 and 157 are uncolored to indicate that the button 153 is in the selected state.

The display field 160 is a field for displaying an icon representing individual electronic money belonging to a group corresponding to the button in the selected state among the buttons 153, 155, and 157. In FIG. 5B, icons 159, 161, and 163 are displayed, which represent the types (brands) of electronic money belonging to the button 153 in the selected state, that is, the transportation electronic money. The icons 159, 161, and 163 represent, for example, Suica of East Japan Railway Company, PASMO of PASMO Co., Ltd., ICOCA of West Japan Railway Company, and the like.

The button 165 is used to display a balance inquiry screen (not illustrated). When the balance inquiry button 165 is operated via the operation inputter 77 in a state where the IC card is set in the IC card reader/writer 79 in a readable/writable manner, the controller 71 reads balance information from the IC card via the IC card reader/writer 79 and displays the value of the read balance on the display 75. The user can check the balance of an IC card of the user by setting the IC card in such a manner that the IC card can be subjected to reading and writing by the IC card reader/writer 79, and operating the balance inquiry button 165 via the operation inputter 77. Thus, the user can determine whether the user can pay the total amount indicated in the amount indication 111 of the payment method selection screen 101 before executing the payment.

The button 167 is an OK button, and is used to confirm that the electronic money payment is made using the IC card selected by the user. When the OK button 167 is operated via the operation inputter 77, the controller 71 determines that electronic money payment is made using the IC card selected on the electronic money selection screen 151. The controller 71 then displays the payment method selection screen 101 on the display 75. The button 169 is a cancel button. When the button 169 is operated via the operation inputter 77, the controller 71 stops the electronic money payment and displays the payment method selection screen 101 on the display 75. The button 171 is an end button. When the button 171 is operated via the operation inputter 77, the controller 71 displays the initial screen (not illustrated) of the expansion device 7 on the display 75.

### 1.3.3 Payment Screen 191

FIGS. 6A and 6B are examples of a screen displayed on the expansion device 7 of the payment system according to the first embodiment of the present disclosure, and a payment screen 191 of FIG. 6A is an example of the payment screen displayed in step S11 of FIG. 3. When the start button 123 is operated on the payment method selection screen 101, the controller 71 displays the payment screen 191 on the display 75. The payment screen 191 includes an electronic money indication 193, an amount indication 195, an IC card placement table image 197, and buttons 199 and 201.

The electronic money indication 193 indicates the classification of the group to which the electronic money selected on the electronic money selection screen 151 belongs. In FIG. 6A, since the IC card of the transportation electronic money is selected on the electronic money selection screen 151, “transportation money” is displayed in the electronic money indication 193.

The amount indication 195 indicates an amount to be paid by the payment. The amount indicated by the amount indication 195 corresponds to the amount indicated in the amount indication 111 on the payment method selection screen 101.

The IC card placement table image 197 is an image illustrating a state in which an IC card is placed on the IC card placement table of the IC card reader/writer 79. The IC card placement table image 197 may be an image of a photograph or an image of an illustration. Displaying the IC card placement table image 197 allows the attention of the user to be called to how to place the IC card.

The button 199 is used to return to the immediately preceding screen. When the return button 199 is operated via the operation inputter 77, the controller 71 displays the payment method selection screen 101 on the display 75. The button 201 is an end button. When the button 201 is operated via the operation inputter 77, the controller 71 displays the initial screen (not illustrated) of the expansion device 7 on the display 75.

### 1.3.4 Payment Completion Screen 211

A payment completion screen 211 in FIG. 6B is an example of the payment completion screen displayed in step S15 in FIG. 3. When the payment processing using the IC card selected on the electronic money selection screen 151 is completed, the controller 71 displays a payment completion screen 211 on the display 75. The payment completion screen 211 includes an electronic money indication 213, money amount indications 215 and 217, and buttons 219 and 221.

The electronic money indication 213 indicates the classification of the group to which the electronic money related to the IC card used for payment belongs. Since the payment completion screen 211 of FIG. 6B is displayed after the payment using the IC card of the transportation electronic money, “transportation money” is displayed in the electronic money indication 213. The amount indication 215 indicates the amount paid by the payment. The amount indication 217 indicates the amount (balance) remaining in the IC card used for the payment after the payment. The button 219 is an OK button indicating that the user has confirmed the display contents of the payment completion screen 211. When the OK button 219 is operated via the operation inputter 77, the controller 71 displays the job execution screen on the display 75. The button 221 is an end button. When the button 221 is operated via the operation inputter 77, the controller 71 displays a screen (not illustrated) on the display 75 to prompt the user to perform refund processing (payment cancellation processing) at a cash register in a store or the like. At this time, the controller 71 may cause an outputter (not illustrated) to output contents necessary for the refund processing (payment cancellation processing).

### 1.3.5 Job Execution Screen 231

FIGS. 7A and 7B are examples of a screen displayed on the expansion device 7 of the payment system according to the first embodiment of the present disclosure. A job execution screen 231 of FIG. 7A is an example of the job execution screen displayed in step S17 of FIG. 3. When the OK button 219 is operated on the payment completion screen 211, the controller 71 displays the job execution screen 231 on the display 75. The job execution screen 231 includes a receipt printing indication 233 and a progress bar 235.

The receipt printing indication 233 is a field for displaying whether to print a receipt, and reflects and displays setting contents related to the receipt printing on the payment method selection screen 101. In the payment method selection screen 101, in a case where the button 119 for printing no receipt is operated (in a case where an operation for printing no receipt is performed), the controller 71 displays “No” in the receipt printing indication 233. When the button 121 for printing a receipt is operated on the payment method selection screen 101 (in a case where an operation for printing a receipt is performed), the controller 71 displays “Yes” in the receipt printing indication 233. FIG. 7A illustrates the receipt printing indication 233 provided when the receipt printing button 121 is operated on the payment method selection screen 101.

The progress bar 235 indicates the progress status of the job being executed. 0% at the left end of the progress bar 235 indicates a situation in which no job is being executed, and 100% at the right end of the progress bar 235 indicates a situation in which execution of the job is completed.

### 1.3.6 Payment Method Selection Screen 241

A payment method selection screen 241 in FIG. 7B is an example of the payment method selection screen displayed in step S33 in FIG. 4. The payment method selection screen 241 includes a number-of-copies indication 243, an amount indication 245, buttons 247 and 249, a receipt printing indication 251, a balloon indication 253, and buttons 255, 257, and 259.

The number-of-copies indication 243 is a numerical value indicating the number of copies to be printed. The amount indication 245 is a numerical value indicating the total amount. The controller 71 calculates a value by multiplying the numerical value displayed in the number-of-copies indication 243 by the amount per copy stored in advance in the storage 73, and displays the calculated numerical value in the amount indication 245.

The button 247 is a button for selecting the cash payment as the payment method, and when the cash button 247 is operated via the operation inputter 77, the controller 71 selects the cash payment as the payment method. The button 249 is a button for selecting the cashless payment as the payment method, and when the cashless button 249 is operated via the operation inputter 77, the controller 71 selects the cashless payment as the payment method. The buttons 247 and 249 are displayed in an (identifiable) display form indicating that one of the buttons is in the selected state. In FIG. 7B, the button 249 is displayed in a colored state representing the selected state.

The receipt printing indication 251 is a field for displaying whether to print a receipt. FIG. 7B illustrates the receipt printing indication 251 provided in the case of printing a receipt. Although not illustrated, whether to print a receipt may be selectable.

The balloon indication 253 is a display field for displaying the payment method started when the start button 255 is operated at the present time, and displays a message indicating that payment is started by the payment method corresponding to the button in the selected state out of the buttons 247 and 249. In FIG. 7B, the button 249 corresponding to the cashless payment is in the selected state, and thus a message “Cashless payment will be started” is displayed in the balloon indication 253.

The button 255 is used to instruct the start of the payment using the payment method corresponding to the selected state of the buttons 247 and 249 and the display of the balloon indication 253. When the start button 255 is operated via the operation inputter 77, the controller 71 displays, on the display 75, a screen corresponding to the selected state of the buttons 247 and 249 and the payment method indicated by the display of the balloon indication 253.

The button 257 is used to return to the job setting screen (not illustrated) displayed in step S31. When the return button 257 is operated via the operation inputter 77, the controller 71 displays the job setting screen on the display 75. The button 259 is used to interrupt (end) execution of the job. When the end button 259 is operated via the operation inputter 77, the controller 71 displays the initial screen (not illustrated) of the expansion device 7 on the display 75.

### 1.3.7 Payment Start Screen 271

FIGS. 8A and 8B are examples of a screen displayed on the expansion device 7 of the payment system 1 according to the first embodiment of the present disclosure. A payment start screen 271 of FIG. 8A is an example of the payment start screen displayed in step S39 of FIG. 4. When the start button 255 is operated on the payment method selection screen 241, the controller 71 displays the payment start screen 271 on the display 75. The payment start screen 271 includes buttons 273, 275, and 277.

The button 273 is a “Yes” button for accepting the start of the payment. When the button 273 is operated via the operation inputter 77, the controller 71 displays a payment terminal guiding animation screen 281 of FIG. 8B on the display 75. The button 275 is a “No” button for stopping the start of the payment. When the No button 275 is operated via the operation inputter 77, the controller 71 returns to step S33 to display the payment method selection screen 241 on the display 75. The button 277 is used to interrupt (end) execution of the job. When the end button 277 is operated via the operation inputter 77, the controller 71 displays the initial screen (not illustrated) of the expansion device 7 on the display 75.

### 1.3.8 Payment Terminal Guiding Animation Screen 281

A payment terminal guiding animation screen 281 of FIG. 8B is an example of the payment terminal guiding animation screen. The payment terminal guiding animation screen 281 is a screen for guiding, to the payment terminal 9, the user who is operating the operation inputter 77 while looking at the display 75 of the expansion device 7. In order to call the attention of the user to more reliably guide the user to the payment terminal 9, the payment terminal guiding animation screen 281 is a moving image that is repeatedly displayed. The payment terminal guiding animation screen 281 may be any moving image as long as the purpose of guiding the user to the payment terminal 9 can be achieved. The following description merely refers to an example of the payment terminal guiding animation screen 281.

The payment terminal guiding animation screen 281 includes an expansion device image 283, a payment terminal image 285, and a message indication 287. On the payment terminal guiding animation screen 281, a portion of the payment terminal image 285 corresponding to the display 95 of the payment terminal 9 is repeatedly blinked to guide the user to the payment terminal 9. Alternatively, an arrow image (not illustrated) indicating the payment terminal image 285 may be displayed in the payment terminal guiding animation screen 281, and the display of the arrow image may be repeatedly blinked. The message indication 287 prompts the user to perform an operation on the payment terminal 9. The message indication 287 displays “Continue operation at the payment terminal on the left side of the main body”.

### 1.4 Effects

According to the first embodiment, the payment processing is performed by the payment processor included in the expansion device, and thus in the first payment processing, which does not need to guide the user to the payment terminal, the payment terminal guiding animation screen is not displayed, and the payment processing is performed by the payment processor included in the external payment terminal. Thus, in the second payment processing, which needs to guide the user to the payment terminal, in a situation where the payment is made using the payment terminal, the payment terminal guiding animation screen is displayed on the display of the expansion device to allow the user to smoothly perform the operation related to the payment processing without being confused regardless of whichever payment processing is executed.

### 2. Second Embodiment

Next, a second embodiment will be described. The second embodiment differs from the first embodiment in the processing performed in a case where the second payment processing is performed and in the processing after the payment terminal guiding animation screen is displayed on display 75 of expansion device 7. Steps S31 to S49 in FIG. 4 are similar to those in the first embodiment, and thus description thereof will be omitted.

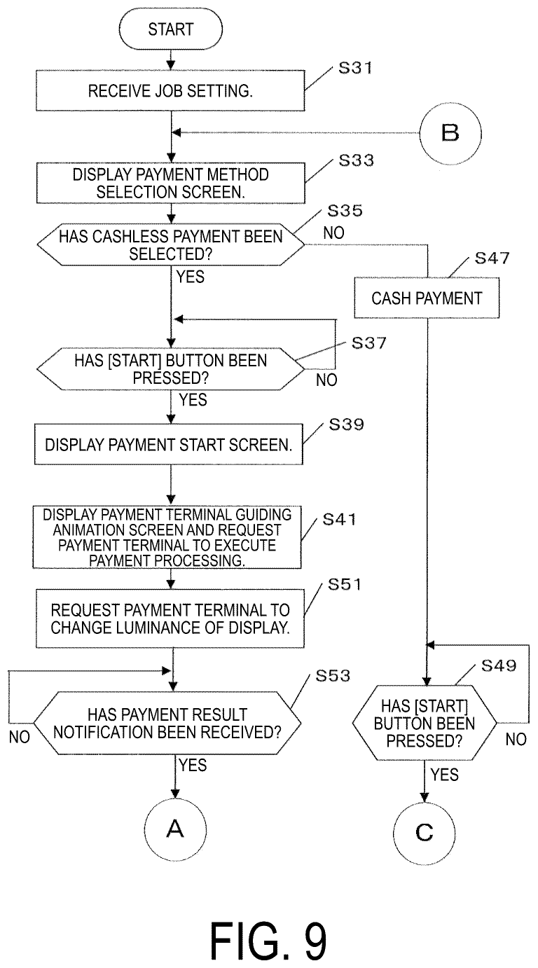

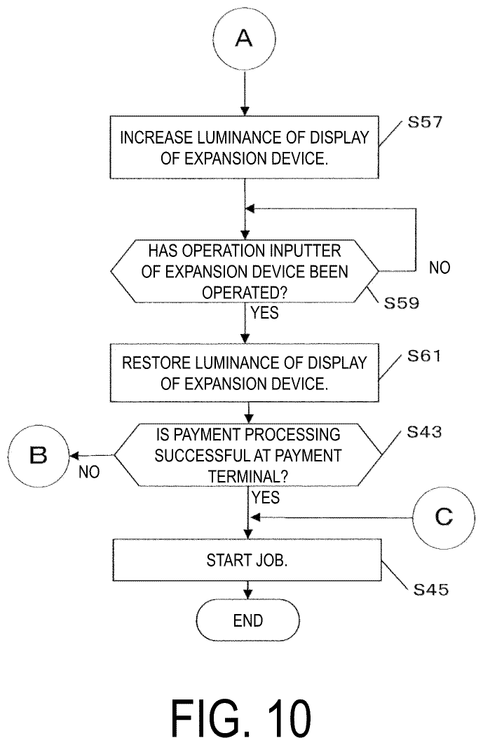

FIG. 9 is the former half of a flowchart for describing operation of the expansion device 7 of the payment system 1 according to the second embodiment of the disclosure. FIG. 10 is the latter half of the flowchart for describing the operation of the expansion device 7 of the payment system 1 according to the second embodiment of the disclosure.

In step S41, after displaying the payment terminal guiding animation screen on the display 75 and instructing the payment terminal 9 to execute the payment processing, the controller 71 transmits, via the connector 81, a luminance change request for requesting the payment terminal 9 to increase the luminance of the display 95 (step S51).

When the payment terminal 9 receives the luminance change request via the connector 99, the controller 91 increases the luminance of the display 95. When the operation inputter 97 receives a certain operation, the controller 91 restores the luminance of the display 95. In this way, by increasing the luminance of the display 95 of the payment terminal 9, the user is more reliably guided to the payment terminal 9. Thereafter, the controller 91 executes the payment processing based on inputs and outputs using the display 95 and the operation inputter 97. Regardless of whether the payment processing succeeds or fails, the controller 91 transmits, to the expansion device 7 via the connector 99, a payment result notification for notifying the expansion device 7 of the success or failure of the payment.

Returning to the expansion device 7, the controller 71 waits for reception of the payment result notification from the payment terminal 9 (No in step S53). Upon receiving the payment result notification via the connector 81 (Yes in step S53), the controller 71 increases the luminance of the display 75 (step S57). Thus, the user who has operated the payment terminal 9 for payment is guided to the expansion device 7.

The controller 71 waits until some operation is performed by the operation inputter 77 (No in step S59), and upon detecting a certain operation (Yes in step S59), the controller 71 restores the luminance of the display 75 (step S61).

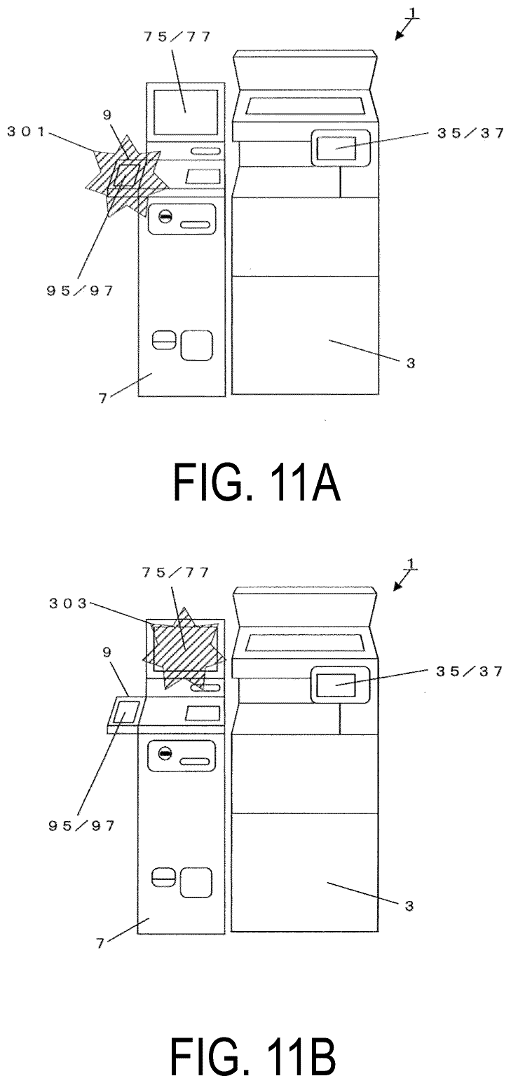

FIGS. 11A and 11B include schematic diagrams for describing the operation of payment system 1 according to the second embodiment of the present disclosure; FIG. 11A is a schematic diagram illustrating control of a light emission state of the display of the payment terminal. FIG. 11A schematically illustrates a state in which the controller 91 increases the luminance of the display 95 in the payment terminal 9 that has received the luminance change request from the expansion device 7 in step S51 as a luminance increase 301.

FIG. 11B is a schematic diagram illustrating the control of the light emission state of the display of the expansion device. FIG. 11B schematically illustrates the state of luminance increase 303 in which, upon receiving the payment result notification from the payment terminal 9, the controller 71 of the expansion device 7 increases the luminance of the display 75 in step S57.

### 2.1 Variation of Second Embodiment

In the above-described second embodiment, the luminance of the display 95 of the payment terminal 9 and the display 75 of the expansion device 7 is increased to guide the user. However, instead of increasing the luminance of the displays 75 and 95, blinking the displays 75 and 95 may be used.

Note that the luminance of the displays 75 and 95 is increased in the second embodiment and the displays 75 and 95 are blinked in the variation of the second embodiment to guide the user but that other than the increase in luminance or the blinking, the light emission state of the displays 75 and 95 may be utilized to guide the user. For example, the change in luminance and the blinking may be combined, and the light emission state of the displays 75 and 95 may be repeatedly changed from the state of luminance 0 to the maximum luminance.

### 2.2 Effects of Second Embodiment and Variation Thereof

According to the second embodiment and the variation thereof, at the timing when the operation on the payment terminal becomes necessary, the luminance of the display of the payment terminal is increased or the display of the payment terminal is blinked to guide the user to the payment terminal. Conversely, at the timing when the operation on the expansion device becomes necessary, the luminance of the display of the expansion device is increased or the display of the expansion device is blinked to guide the user to the expansion device. Thus, according to the second embodiment, at the necessary timing, the device that needs to be operated can be used to effectively guide the user to the device.

### 3. Third Embodiment

A third embodiment will now be described. As compared with the first embodiment, the third embodiment uses an expansion device 7A instead of the expansion device 7, and uses a payment terminal 9A instead of the payment terminal 9. In the second embodiment, the light emission state of the displays 75 and 95 is changed to guide the user. However, in the third embodiment, voice outputters 315 and 319 output a voice message to guide the user.

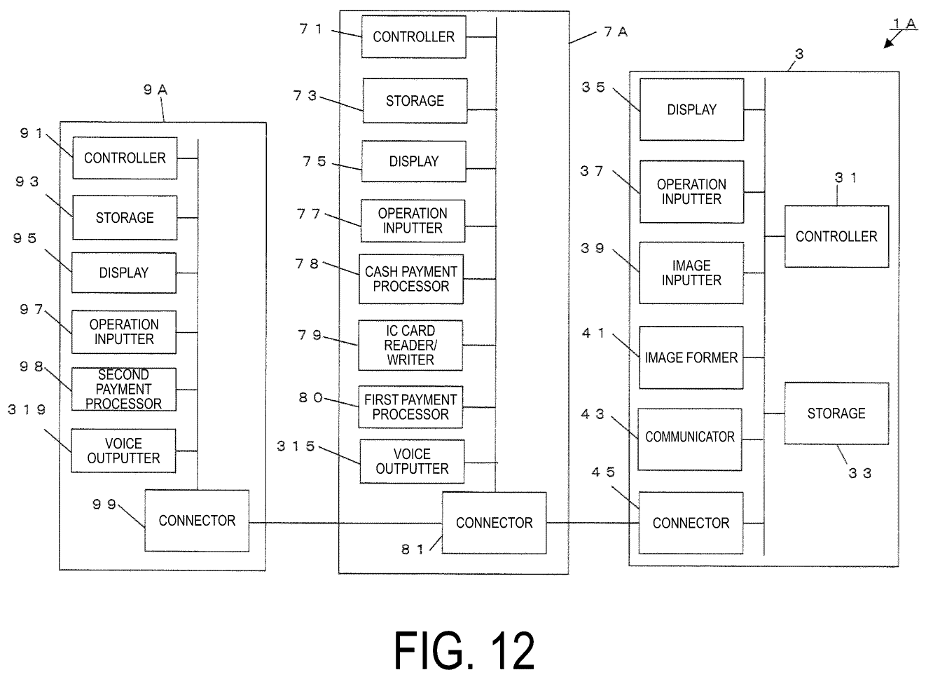

FIG. 12 is a functional block diagram of a payment system 1A according to a third embodiment of the disclosure. In the payment system 1A, the expansion device 7A and the payment terminal 9A include voice outputters 315 and 319, respectively. The voice outputters 315 and 319 may be built in the expansion devices 7A and the payment terminals 9A, respectively, or may be external devices externally attached via the connectors 81 and 99 of the expansion devices 7A and the payment terminals 9A, respectively.

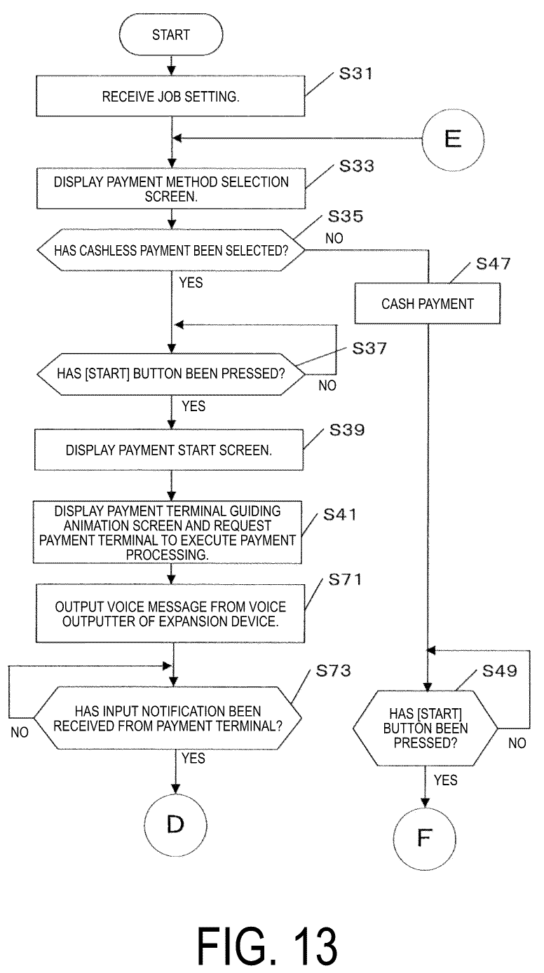

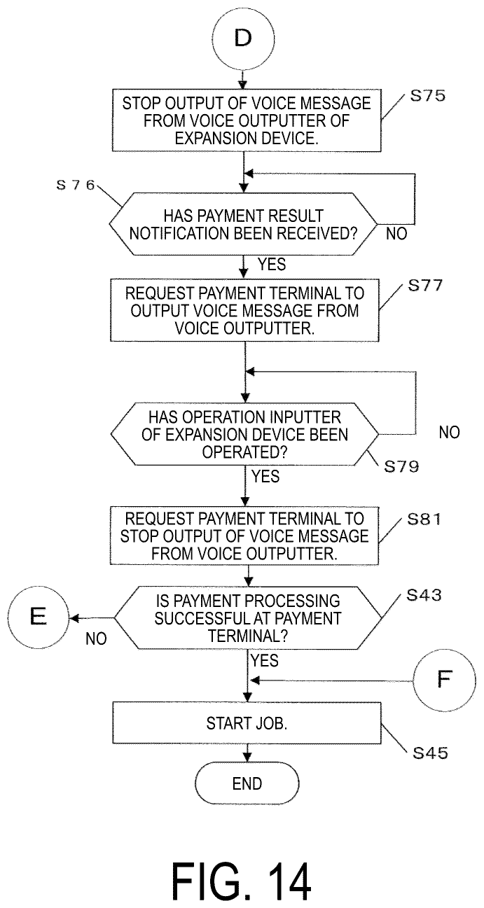

FIG. 13 is the former half of a flowchart for describing operation of the expansion device 7A of the payment system 1A according to the third embodiment of the present disclosure. FIG. 14 is the latter half of the flowchart for describing the operation of the expansion device 7A of the payment system 1A according to the third embodiment of the present disclosure. Steps S31 to S49 are similar to those in the first embodiment, and thus description thereof will be omitted.

In step S41, the controller 71 displays the payment terminal guiding animation screen on the display 75, transmits the payment request to the payment terminal 9A, and then outputs the voice message from the voice outputter 315 (S71). The voice message is used to guide the user from the expansion device 7A to the payment terminal 9A.

The controller 71 waits until the controller 71 receives an input notification from the payment terminal 9A via the connector 81 (No in step S73). Here, the input notification from the payment terminal 9A is a signal that the controller 91 transmits to the expansion device 7A via the connector 99 according to the content of a certain operation when the operation inputter 97 receives the operation. Upon receiving the input notification from the payment terminal 9A (Yes in step S73), the controller 71 stops outputting the voice message from the voice outputter 315 (S75).

Then, the controller 71 waits until the controller 71 receives the payment result notification via the connector 81 (No in step S76). The payment result notification is a notification related to the result of the payment processing executed by the controller 91 based on the operation of the user on the operation inputter 97 in the payment terminal 9A that has received the payment request from the expansion device 7A via the connector 99. Upon receiving the payment result notification (Yes in step S76), the controller 71 transmits, to the payment terminal 9A, the voice message output request for requesting output of the voice message (step S77). When the payment terminal 9A receives the voice message output request is received via the connector 99, the controller 91 outputs the voice message from the voice outputter 319 in response to the voice message output request. The voice message is used to guide the user from the payment terminal 9A to the expansion device 7A.

After step S77, the controller 71 waits for reception, via the connector 81, of a notification related to the content of an operation performed by the user on the operation inputter 77 (No in step S79). Upon receiving the notification (Yes in step S79), the controller 71 transmits, to the payment terminals 9A via the connector 81, a voice message output stop request to stop outputting the voice message (step S81). When the payment terminal 9A receives the voice message stop request via the connector 99, the controller 91 stops outputting the voice message from the voice outputter 319.

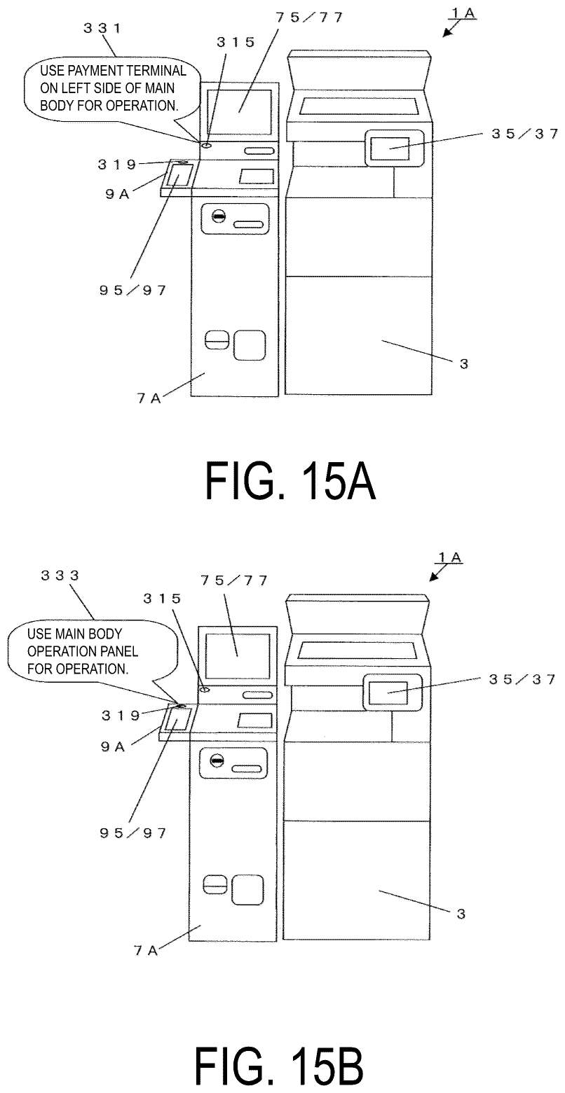

FIGS. 15A and 15B include schematic diagrams illustrating operation of the payment system 1A according to the third embodiment of the present disclosure; FIG. 15A is a schematic diagram illustrating a state in which the expansion device 7A outputs a voice message guiding the user to the payment terminal 9A. FIG. 15A a schematically illustrates a state in which the controller 71 outputs the voice message 331 from the voice outputter 315 of the expansion device 7A in step S71.

FIG. 15B is a schematic diagram illustrating a state in which the payment terminal 9A outputs a voice message guiding the user to the expansion device 7A. FIG. 15B schematically illustrates a state in which the controller 91 of the payment terminal 9A outputs the voice message from the voice outputter 319 in response to the voice message output request transmitted by the controller 71 in step S77.

As described above, according to the third embodiment, the voice message is output from the voice outputter 315 of the expansion device 7A to guide the user to the payment terminal 9A at the timing when the operation on the payment terminal 9A becomes necessary. At the timing when the operation on the expansion device 7A becomes necessary, the voice message is output from the voice outputter 319 of the payment terminal 9A to guide the user to the expansion device 7A. Thus, according to the third embodiment, at the necessary timing, the user can be more effectively guided to the device that needs to be operated.

### 4. Fourth Embodiment

A fourth embodiment will now be described. In the first embodiment, in step S41, the payment terminal guiding animation screen is displayed on the display 75 to guide the user to the payment terminals 9. In the fourth embodiment, in a case where, among the plurality of operation inputters 37, 77, and 97 included in the payment system 1, an operation inputter other than the operation inputter of the device that needs to be operated is operated, a message is displayed on the display corresponding to the erroneously operated operation inputter. The message is used to guide the user to the device that needs to be operated.

Specifically, the operation inputter 37 or 77 of the image forming apparatus 3 or the expansion device 7 is assumed to be operated in a situation in which the operation inputter 97 of the payment terminal 9 needs to be operated. In this case, for example, a message “Use the left (leftmost) operation panel for operation” is displayed on the display 35 or 75 of the image forming apparatus 3 or the expansion device 7. The operation inputter 37 or 97 of the image forming apparatus 3 or the payment terminal 9 is assumed to be operated in a situation in which the operation inputter 77 of the expansion device 7 needs to be operated. In this case, for example, a message “Use the central operation panel for operation” is displayed on the display 35 or 95 of the image forming apparatus 3 or the payment terminal 9. In the present embodiment, the operation on the image forming apparatus 3 is not required, and thus no situation occurs in which the operation inputter 37 needs to be operated.

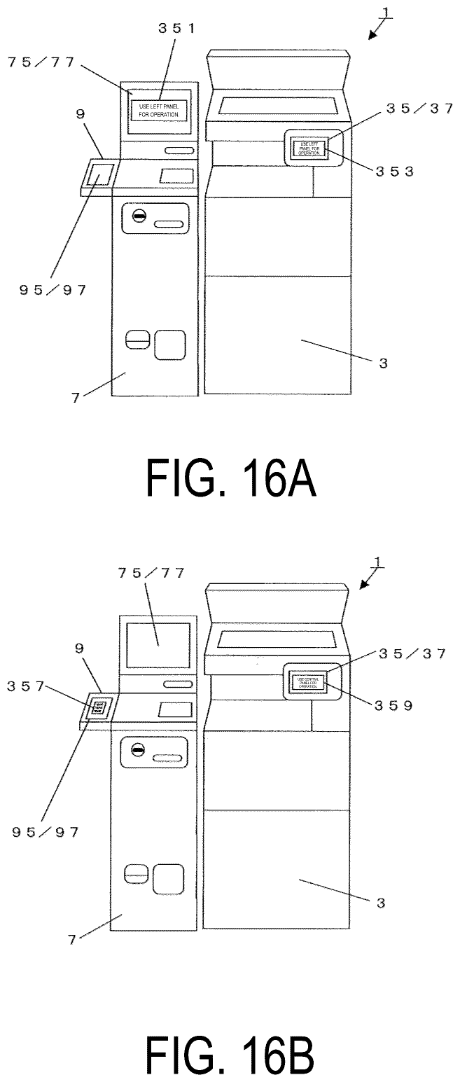

FIGS. 16A and 16B include schematic diagrams for describing operation of the payment system 1 according to the fourth embodiment of the present disclosure; FIG. 16A is a schematic diagram illustrating a state in which the image forming apparatus 3 and the expansion device 7 display messages 351 and 353 guiding the user to the payment terminal 9. In step S41 of FIG. 4, instead of displaying the payment terminal guiding animation screen, the controller 31 displays the message 351 on the display 75 and displays the message 353 on the display 35. The messages 351, 353 are each a text message “Use the left panel for operation”. Here, the “left panel” indicates the display located on the left side when viewed from the user, that is, the display 95.

FIG. 16B is a schematic diagram illustrating a state in which the payment terminal and the image forming apparatus display messages 357 and 359 guiding the user to the expansion device. In step S45 in FIG. 4, the controller 31 displays the job execution screen on the display 75 to start the job, and also displays the message 359 on the display 35. In the same step, controller 31 further transmits a message indication request for requesting display of a message to the payment terminal 9 via the connector 45. In the payment terminal 9, when the connector 99 receives the message indication request, the controller 91 displays the message 357 on the display 95. The messages 357 and 359 are each a text message “Use the central panel for operation”. Here, the “central panel” indicates the display located at the center when viewed from the user among the three displays 35, 75, and 95, that is, the display 75.

Although the messages 351, 353, 357, and 359 have been described as text messages, these messages need not be in text form. For example, an animation screen such as the payment terminal guiding animation screen may be used. A still image such as an illustration or a photograph may be used which represents the guiding destination device.

According to the fourth embodiment, the display 35 of the image forming apparatus 3 displays the message guiding the user, in addition to the display 75 of the expansion device 7A and the display 95 of the payment apparatus 9A. Thus, according to the fifth embodiment, at the necessary timing, the user can be more effectively guided to the device that needs to be operated.

### 5. Fifth Embodiment

A fifth embodiment will now be described. In the fifth embodiment, a forget-something prevention screen is displayed on the display 75 after the execution of the job is completed, to be specific, after the execution of step S17 in FIG. 3 and step S45 in FIGS. 4, 10, and 14. In the fifth embodiment, the type of the job executed in step S17 or S45 is determined, and the forget-something prevention screen corresponding to the type is displayed.

The user may utilize an administrative service in the payment system 1 to acquire a Copy of Resident Record or a certificate of seal registration. Items that the user utilizing the administrative service may leave behind at the payment system 1 include an Individual Number Card used to utilize the administrative service, various documents acquired utilizing the administrative service, change resulting from the cash payment, any of various cards and a smartphone used for the cashless payment, and the like. In a case where the administrative service is utilized, the user need not prepare any document as in the case of, for example, copying.

Thus, in a case where the job related to the administrative service is executed in step S17 or S45, the controller 71 displays the forget-something prevention screen 371 on the display 75.

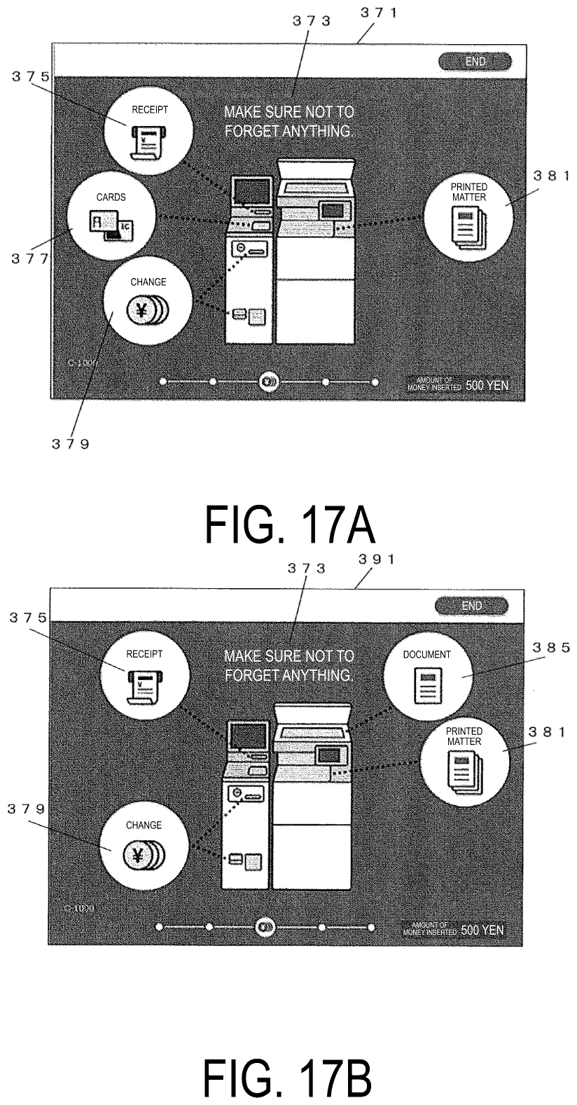

FIGS. 17A and 17B are examples of a screen displayed on the expansion device 7 of the payment system 1 according to the fifth embodiment of the present disclosure, and the forget-something prevention screen 371 of FIG. 17A is an example of a screen displayed after utilization of the administrative service. The forget-something prevention screen 371 includes a message 373 and illustrations 375, 377, 379, and 381.

The message 373 calls the attention of the user to prevention of forgetting something. Here, the message reads “Make sure not to forget anything”. The illustration 375 represents a receipt. The illustration 377 represents cards such as Individual Number Cards. The illustration 379 represents change. The illustration 381 indicates printed matter. Here, the printed matter is a Copy of Resident Record, a certificate of seal registration, or the like.

On the other hand, the user may utilize a copy service in the payment system 1. In this case, the items the user may leave behind at the payment system 1 include a receipt, change, a document, printed matter, any of various cards and a smartphone used for the cashless payment, and the like.

Thus, in a case where the job related to the copy service is executed in step S17 or S45, the controller 71 displays the forget-something prevention screen 391 on the display 75. The forget-something prevention screen 391 in FIG. 17B is an example of a screen displayed after the copy service is utilized. The forget-something prevention screen 391 includes illustrations 375, 379, 381, and 385. The illustration 385 indicates a document.

When the copy service is utilized, a document to be copied may be forgotten. Thus, the forget-something prevention screen 391 includes the illustration 385 indicating a document. The copy service does not normally use the Individual Number card, and thus the Individual Number Card is unlikely to be forgotten. Thus, the forget-something prevention screen 391 does not include the illustration 377 indicating cards or the like. Note that the cashless payment utilizes an IC card and thus that the forget-something prevention screen 391 also preferably includes the illustration 377 indicating cards. In this case, no change results, and thus a forget-something prevention screen is preferably displayed that is obtained by removing, from the forget-something prevention screen 391, the illustration 379 indicating change.

According to the fifth embodiment, since the forget-something prevention screen having different contents is displayed according to the type of the executed job, the attention of the user can be called to forget-something prevention according to the type of the executed job.

### 6. Sixth Embodiment

A sixth embodiment will be described. As in the fifth embodiment, in the sixth embodiment, the forget-something prevention screen is displayed on the display 75 after the execution of the job is completed, to be more specific, after the execution of step S17 in FIG. 3 and step S45 in FIGS. 4, 10, and 14. In the fifth embodiment, the forget-something prevention screen corresponding to the type of job is displayed, but in the sixth embodiment, the forget-something prevention screen corresponding to the utilized payment method is displayed.

In the cash payment, change may be forgotten. On the other hand, the cashless payment does not involve forgetting of change, but may involve forgetting of a credit card, a smartphone, or the like used for the cashless payment. In view of this, in the sixth embodiment, the forget-something prevention screen corresponding to the payment method is displayed.

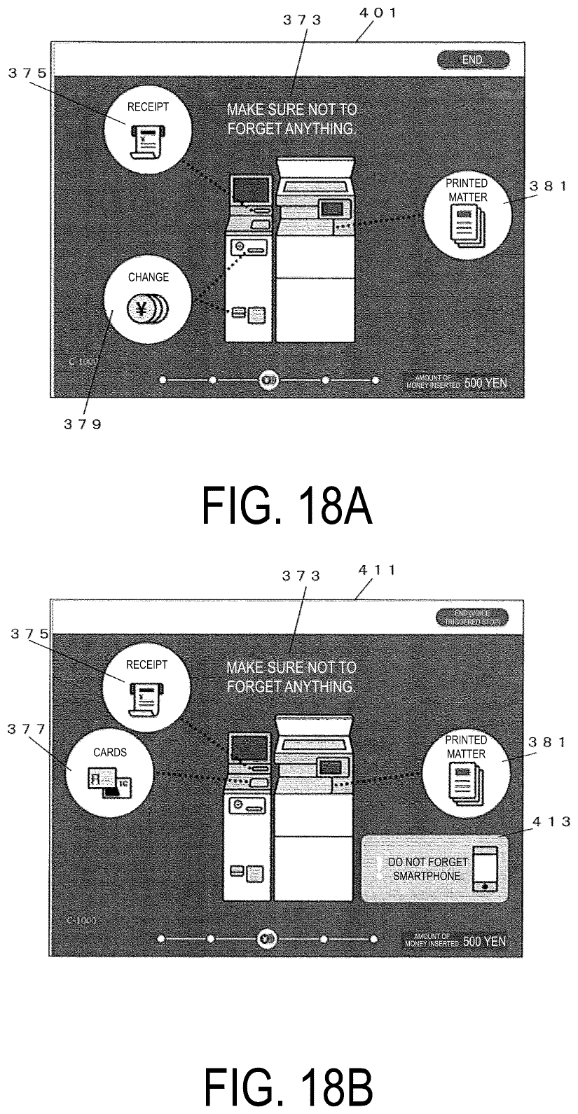

FIGS. 18A and 18B are examples of a screen displayed on the expansion device 7 of the payment system 1 according to the sixth embodiment of the present disclosure. A forget-something prevention screen 401 in FIG. 18A is an example of a screen displayed when the payment is made by cash. In the first payment processing in FIG. 3, in a case where the cash payment is selected in step S5, the controller 71 displays the forget-something prevention screen 401 on the display 75 after completion of the job started in step S17. In the second payment processing in FIG. 4, when the cash payment is selected in step S35, the forget-something prevention screen 401 is displayed.

The forget-something prevention screen 401 includes a message 373 and illustrations 375, 379, and 381. The cash payment may involve change, and thus the forget-something prevention screen 401 includes the illustration 379 indicating change.

The forget-something prevention screen 411 in FIG. 18B is an example of a screen displayed when the cashless payment is made. In the second payment processing in FIGS. 4, 9, and 13, when cashless payment (electronic-money payment) is selected in step S35, the controller 71 displays the forget-something prevention screen 411 after completion of the job started in step S45. In the first payment processing in FIG. 3, the forget-something prevention screen 411 is also displayed in a case where the electronic-money payment is selected in step S5.

The forget-something prevention screen 411 includes a message 373, illustrations 375, 377, and 381, and a message 413. Since the cashless payment (electronic money payment) involves no change, the forget-something prevention screen 411 does not include the illustration 379 indicating change. Instead, the cashless payment (electronic money payment) may use credit card or a smartphone. Thus, the forget-something prevention screen 411 includes the illustration 377 indicating cards or the like and the message 413 calls the attention of the user to prevention of forgetting a smartphone.

According to the sixth embodiment, since the forget-something prevention screen having different contents is displayed according to the utilized payment method, the attention of the user can be called to prevention of forgetting something according to the payment method.

### 7. Variations

The disclosure is not limited to the embodiments and variations thereof described above and can be changed in various manners. That is, embodiments obtained by combining technical mechanisms appropriately changed without departing from the gist of the disclosure are also included in the technical scope of the disclosure.

It will be apparent to those skilled in the art that the first to sixth embodiments described above can be implemented in combination. For example, although the luminance of the display of the payment terminal is changed in the second embodiment and the voice message is output in the third embodiment, to guide the user, both these user guiding operations can be performed. Although the fifth embodiment and the sixth embodiment have been described on the assumption that the forget-something prevention screen is displayed based on the first embodiment, the forget-something prevention screen can be displayed based on the second embodiment, the third embodiment, and the fourth embodiment.

In the second embodiment and the variation thereof, in addition to the display of the payment terminal guiding screen, the luminance change or blinking of the display is used to guide the user. In the third embodiment, the voice message is output to guide the user. The execution of the output for guiding the user to the payment terminal need not necessarily follow the display of the payment terminal guiding screen. The luminance change or blinking of the display or the output of the voice message may be simultaneous with the display of the payment terminal guiding screen or may follow the display of the payment terminal guiding screen.

In the description of the first embodiment, the electronic money payment is used as a payment method other than the cash. However, the disclosure is not limited to this, and the cashless payment other than the electronic money payment may be used. For example, smart phone payment, credit card payment, or debit card payment may be used. The smartphone payment is a payment method in which the payment is made utilizing a payment dedicated application downloaded to a smartphone. The credit card payment is a payment method in which the payment is made by inserting or holding a credit card into or over a dedicated terminal at a cash register in a store or by inputting a card number, an expiration date, and the like of the credit card on a payment screen on a website. The debit card payment is a payment method that is performed by using a card as is the case with the credit card payment, and in which a utilized amount is debited from a bank account immediately after payment.

In the description of the fifth embodiment, the forget-something prevention screens 371 and 391 illustrated in FIGS. 17A and 17B are displayed. However, another forget-something prevention screen may be displayed according to the utilization situation of the service in the payment system 1 (the operation of the user or the operations of the image forming apparatus 3, the expansion device 7, and the payment terminal 9). For example, a forget-something prevention screen may be displayed that is obtained by removing, from the forget-something prevention screens 371 and 391, the illustration 375 representing a receipt in a case where the user does not perform an operation of printing a receipt. The forget-something prevention screen 371 or 391 may be displayed without any change in a case where the cash payment is selected, whereas a forget-something prevention screen may be displayed that is obtained by removing, from the forget-something prevention screen 371 or 391, the illustration 379 representing change in a case where the cashless payment is selected.

In the description of the sixth embodiment, the forget-something prevention screens 401 and 411 of FIGS. 18A and 18B are displayed. However, another forget-something prevention screen may be displayed according to the utilization situation of the service in the payment system 1 (the operation of the user or the operations of the image forming apparatus 3, the expansion device 7, and the payment terminal 9). For example, in a case where the user does not perform an operation of printing a receipt, a forget-something prevention screen may be displayed that is obtained by removing, from the forget-something prevention screens 401 and 411, the illustration 375 illustrating a receipt.

Although the image forming apparatus 3 and the expansion device 7 are described as separate devices in the above-described embodiment, the image forming apparatus 3 may be integrated with the expansion device 7. In this case, the image forming apparatus 3 further includes a cash payment processor 78, an IC card reader/writer 79, and a first payment processor 80. The controller 31, the storage 33, the display 35, the operation inputter 37, and the connector 45 of the image forming apparatus 3 also operate as the controller 71, the storage 73, the display 75, the operation inputter 77, and the connector 81 of the expansion device 7, respectively.

In the first embodiment, the payment system 1 is described as being capable of executing only one of the first and second payment processing operations, which are cashless payments. However, the payment system 1 may be capable of executing both payment processing operations. For example, a title “electronic money” at the upper left of the electronic money selection screen 151 in FIG. 5B is changed to “cashless payment”, with the button 155 changed to a “two-dimensional code payment” button. In response to an operation of selecting the button 155, two-dimensional code payments that can be executed by the second payment processor 98 (for example, PayPay of PayPay Corporation, Rakuten Pay of Rakuten Payment, Inc., LINE Pay of LY Corporation, D PAYMENT of NTT DOCOMO, INC., and the like) are displayed in the display field 160. When the OK button 167 is operated in a state where the button 155 is selected and the type of two-dimensional code payment to be utilized is selected, steps S39, S41, S43, and S45 in FIG. 4 are executed.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

The recording medium storing the programs may be any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like. Not only the aforementioned functions of the embodiments are implemented by executing the loaded programs, but also the functions of the disclosure may be implemented by performing processing in cooperation with an operating system, another application program, or the like based on commands of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the disclosure.

### DESCRIPTION OF REFERENCE CHARACTERS

1, 1A Payment system
3 Image forming apparatus (MFP, Multi-Function Printer/Peripheral)
7, 7A Expansion device
9, 9A Payment terminal (external terminal)
31, 71, 91 Controller
33, 73, 93 Storage
35, 75, 95 Display
37, 77, 97 Operation inputter
39 Image inputter
41 Image former
43: Communicator
45, 81, 99 Connector
78 Cash payment processor
79 IC card reader/writer
80, 98 Payment processor
101, 241 Payment method selection screen
103, 243 Number-of-copies indication
105, 107, 109, 115, 117, 119, 121, 123, 129, 131, 153, 155, 157, 165, 167, 169, 171, 199, 201, 219, 247, 249, 255, 257, 259, 273, 275, 277 Button
111, 195, 215, 217, 245 Amount indication
113 Payment method indication
125, 253 Balloon indication
127, 287 Message indication
151 Electronic money selection screen
159, 161, 163 Icon
160 Display field
191 Payment screen
193, 213 Electronic money indication
197 IC card placement table image
211 Payment completion screen
231 Job execution screen
233, 251 Receipt printing indication
235 Progress bar
271 Payment start screen
281 Payment terminal guiding animation screen
283 Expansion device image
285 Payment terminal image
301, 303 Luminance increase
315, 319 Voice outputter
331, 333 Voice message
351, 353, 357, 359, 373, 413 Message
371, 391, 401, 411 Forget-something prevention screen
375, 377, 379, 381, 385 Illustration

1. An information processing apparatus comprising:
one or more controllers;
a display;
a first payment processor that executes first payment processing; and
a connector that is connectable to a payment terminal that executes second payment processing, wherein
the one or more controllers
display, on the display, a payment screen related to the first payment processing when executing the first payment processing by the first payment processor, and
display, on the display, a payment terminal guiding screen used to guide a user to the payment terminal when requesting, via the connector, the payment terminal to execute the second payment processing.

2. The information processing apparatus according to claim 1, wherein
the one or more controllers request the payment terminal to execute output for guiding the user to the payment terminal before and/or after the payment terminal guiding screen is displayed.

3. The information processing apparatus according to claim 2, wherein
the one or more controllers request the payment terminal to change luminance of a display of the payment terminal before and/or after the payment terminal guiding screen is displayed.

4. The information processing apparatus according to claim 2, wherein
the one or more controllers request the payment terminal to blink a display of the payment terminal before and/or after the payment terminal guiding screen is displayed.

5. The information processing apparatus according to claim 1, wherein
the one or more controllers cause a voice message guiding the user to be output from a voice outputter included in the information processing apparatus or connected to the one or more controllers via the connector.

6. The information processing apparatus according to claim 5, wherein
the one or more controllers cause the voice outputter to output the voice message guiding the user to the payment terminal when requesting, via the connector, the payment terminal to execute the second payment processing.

7. The information processing apparatus according to claim 5, wherein
upon receiving, from the payment terminal via the connector, a notification related to a result of execution of the second payment processing, the one or more controllers request the voice outputter of the payment terminal to output a voice message guiding the user to the information processing apparatus.

8. The information processing apparatus according to claim 1, wherein
the connector is connected to an image forming apparatus including an operation inputter and a display, and
when the operation inputter of the image forming apparatus is operated, the one or more controllers cause the display of the image forming apparatus to display a screen calling attention.

9. The information processing apparatus according to claim 1, wherein
the connector is connected to an image forming apparatus including an operation inputter and a display, and
in a case where the first payment processing or the second payment processing is successful, the one or more controllers request the image forming apparatus to execute a job,
the one or more controllers display, on the display, a forget-something prevention screen used to call attention to prevention of forgetting something, and
the forget-something prevention screen includes a display content corresponding to a type of the executed job.

10. The information processing apparatus according to claim 1, further comprising:
a cash payment processor, wherein
after executing any of the first payment processing, second payment processing, and cash payment processing, the one or more controllers displays, on the display, a forget-something prevention screen used to call attention to prevention of forgetting something, and
the forget-something prevention screen includes a display content corresponding to the executed payment processing among the first payment processing, the second payment processing, and the cash payment processing.

11. A method of controlling an information processing apparatus including a display, a first payment processor that executes first payment processing, and a connector that is connectable to a payment terminal that executes second payment processing, the method comprising:
displaying, on the display, a payment screen related to the first payment processing when executing the first payment processing by the first payment processor; and
displaying, on the display, a payment terminal guiding screen used to guide a user to the payment terminal when requesting, via the connector, the payment terminal to execute the second payment processing.
